(19) United States
(12) Patent Application Publication
(10) Pub. No.: US 2019/0048180 A1
(43) Pub. Date: Feb. 14, 2019

(54) SOFT CONTACT LENS MATERIAL WITH LOW VOLUMETRIC EXPANSION UPON HYDRATION

(71) Applicant: OneFocus Vision, Inc., Fernandina Beach, FL (US)

(72) Inventors: Adam Harant, Boulder, CO (US); Neil CRAMER, Boulder, CO (US); Amelia DAVENPORT, Broomfield, CO (US); Steve WAITE, Fernandina Beach, FL (US); Amitava GUPTA, Roanoke, VA (US)

(21) Appl. No.: 15/972,900

(22) Filed: May 7, 2018

Related U.S. Application Data
(63) Continuation of application No. PCT/US16/61696, filed on Nov. 11, 2016.
(60) Provisional application No. 62/254,048, filed on Nov. 11, 2015.

(51) Int. Cl. C08L 33/10; G02B 1/04; C08L 33/06; C08L 33/26; C08L 39/06; G02C 7/08; G02C 7/04; C08F 8/30

(52) U.S. Cl. CPC C08L 33/10; G02B 1/043; C08L 33/066; C08L 33/26; C08L 2312/00; G02C 7/085; G02C 7/048; C08F 8/30; C08L 2203/02; C08L 39/06

(57) ABSTRACT

A hydrogel formulation has been developed that can be cast to form a hydrophilic cross-linked network with water content of 30-60% by weight that undergoes a volume expansion less than 5% when equilibrated in water or an aqueous solution of ionic species. This hydrogel formulation was used to cast a soft contact lens incorporating an insert that may be a sealed module filled with a fluid. Diameter of lenses cast without an insert measured within 0.5-5.0% of the target diameter after hydration. The interface between the hydrogel and the insert in lenses cast with an insert remaining stress free after hydration, when the lens was inspected under a microscope. The formulation comprises and may consist of a mixture of hydrophilic mono-functional monomers, cross-linking agents, a photo-curing catalyst and a diluent.

### CROSS-REFERENCE

This application is a continuation of PCT/US2016/061696, filed on Nov. 11, 2016, entitled “SOFT CONTACT LENS MATERIAL WITH LOW VOLUMETRIC EXPANSION UPON HYDRATION” [attorney Docket No.: 44910-710.601], which claims the benefit of U.S. Provisional Application No. 62/254,048, filed Nov. 11, 2015, entitled “SOFT CONTACT LENS MATERIAL WITH LOW VOLUMETRIC EXPANSION UPON HYDRATION” [attorney docket no. 44910-710.101], which applications are incorporated herein by reference.

The subject matter of the present application is related to the following patent applications: PCT/US2014/013427, filed on Jan. 28, 2014, entitled “Accommodating Soft Contact Lens” [attorney docket no. 44910-703.601]; PCT/US2014/013859, filed on Jan. 30, 2014, entitled “Manufacturing Process of an Accommodating Contact Lens” [attorney docket no. 44910-704.601]; PCT/US2014/071988, filed on Dec. 22, 2014, entitled “Fluidic Module For Accommodating Soft Contact Lens” [attorney docket no. 44910-705.601]; U.S. Application Ser. No. 62/031,324, filed Jul. 31, 2014, entitled “Sacrificial Molding Process for an Accommodating Contact Lens” [attorney docket no. 44910-707.101]; PCT/US2015/0433307, filed 31 Jul. 2015, entitled “LOWER LID ACTIVATING AN ELECTRONIC LENS”; PCT/US2016/061697, filed on Nov. 11, 2016, entitled “ROTATIONALLY STABILIZED CONTACT LENS” [attorney docket number 44910-711.601]; and PCT/US2016/061700, filed on Nov. 11, 2016, entitled “ACCOMMODATING LENS WITH CAVITY” [attorney docket number 44910-712.601]; the entire disclosures of which are incorporated herein by reference.

The subject matter of the present application is also related to the following provisional patent applications: U.S. Prov. Ser. App. No. 62/254,080, filed Nov. 11, 2015, entitled “ROTATIONALLY STABILIZED CONTACT LENS” [attorney docket number 44910-711.101]; U.S. Prov. Ser. App. No. 62/255,242, filed Nov. 13, 2015, entitled “ROTATIONALLY STABILIZED CONTACT LENS” [attorney docket number 44910-711.102]; U.S. Prov. Ser. App. No. 62/254,093, filed Nov. 11, 2015, entitled “ACCOMMODATING LENS WITH CAVITY” [attorney docket number 44910-712.101]; and U.S. Prov. Ser. App. No. 62/327,938, filed Apr. 26, 2016, entitled “ACCOMMODATING LENS WITH CAVITY” [attorney docket number 44910-712.102]; the entire disclosures of which are incorporated herein by reference.

### BACKGROUND OF THE INVENTION

The expansion of soft contact lenses upon hydration can pose significant challenges to lens designers as they seek to develop better and more precise optical and mechanical designs for better on-eye performance. Ophthalmic lenses can be used in many applications such as contact lenses and intraocular lenses. The prior polymers can be less than ideally suited for use with ophthalmic lenses. For example, soft contact lenses bearing embedded inserts can become distorted upon hydration, since the interface between the insert and the hydrogel material may be subjected to a three-dimensional stress field caused by the differential expansion of the hydrogel layer relative to the surface of the insert.

As soft contact lenses are developed with enhanced functionality in which inserts are added to provide such enhancements, the need to lower the volume expansion of the hydrogel material (“low expansion hydrogel”) comprising the soft contact lens will become even more relevant. For example, the prior polymer materials can be less than ideally suited for use with electronic soft contact lenses. These electronic soft contact lenses can incorporate components that do not expand with the hydrogel material. Examples of soft contact lenses with such components may include: electronic or electro-optical components; diagnostic soft contact lenses designed to incorporate sensor components; and soft contact lenses designed to deliver drugs into the eye. These soft contact lenses may benefit from a fabrication process in which the carrier soft contact lens will remain distortion free while incorporating inserts.

In light of the above, there is therefore for improved hydrogel compositions and contact lenses. Ideally such hydrogel compositions would have decreased expansion upon hydration.

### SUMMARY OF THE INVENTION

The methods, apparatus, and formulations disclosed herein may comprise a low expansion hydrogel material having fully hydrated percent hydration in the range 30-60%, preferably 35-55%, and have a net volumetric expansion of less than 5%, preferably less than 2% upon hydration. The polymers disclosed herein will find wide applications in fabrication of biomedical implants and other biocompatible articles of manufacture. For example, hydrophilic intraocular lenses may rely on casting with molds incorporating precision optical elements that benefit from the polymers disclosed herein in order to provide precise, submicron scale replication.

A formulation has been developed comprising a mixture of polymerized hydrophilic acrylates and methacrylates, a water-soluble diluent, and a photo-curing catalyst that when cured and hydrated forms a cross-linked polymer. A volume of said cross-linked polymer is configured to expand less than 5% by volume upon hydration to within a range of 30-65% water. This formulation may be cast to form a hydrophilic cross-linked network with water content of 30-60% by weight that undergoes a volume expansion less than 5% when equilibrated in water or an aqueous solution of ionic species. This formulation may also be cast to form a soft contact lens incorporating an insert, such as a sealed module filled with a fluid.

In many embodiments, a polymeric hydrogel material comprises or consists of a cured and hydrated mixture of polymerized hydrophilic acrylates and methacrylates, a water-soluble diluent, and a photo-curing catalyst, wherein said polymeric hydrogel material has expanded less than 5% by volume upon hydration to within a range of 30-65% water.

The formulation can be combined with an insert to form a contact lens or other lens. The insert may comprise a module such as a fluidic module or other module, and can be combined with the low expansion polymer to inhibit distortion and provide improved optical performance of the lens when hydrated.

In a first aspect, a formulation is provided. The formulation comprises or optionally consists of a mixture of polymerized hydrophilic acrylates and methacrylates, a water-soluble diluent, and a photo-curing catalyst that when cured and hydrated forms a cross-linked polymer. A volume of the cross-linked polymer is configured to expand less than 5% by volume upon hydration to within a range of 30-65% water. The cross-linked polymer may expand less than 1% by volume upon hydration to within a range of 30-65% water. The hydration may comprise hydration at 25 C.°.

In many embodiments, the cross-linked polymer may comprise methacrylate. The methacrylate may comprise glyceryl monomethacrylate in the range of 18-25%.

In many embodiments, the cross-linked polymer may have a refractive index in the range of 1.39-1.44 in the hydrated state.

In many embodiments, the water-soluble diluent may comprise a polyethylene glycol of viscosity in the range of 6-20 cSt at 25 C.°.

In many embodiments, the photo-curing catalyst may be capable of being activated by ultraviolet radiation in the wavelength range of 350-440 nm.

In many embodiments, the formulation may be non-ionic.

In many embodiments, the formulation may comprise a cross-linker. The cross-linker may comprise a multifunctional methacrylate. The cross-linker may comprise a trifunctional methacrylate, in a weight range of 1.0-2.5% of the cured cross-linked polymer prior to hydration.

In many embodiments, the cross-linked polymer may be comprised of one or more of a mono-functional monomer or multi-functional monomer. The mono-functional monomer may comprise hydroxyethyl methacrylate (HEMA), 2-methoxyethyl methacrylate (MEMA), glyceryl mono-methacrylate (GMA), methacrylic acid (MAA), Aminoethyl methacrylate, acrylamide, 2-vinyl pyrollidone, polyethylene glycol methacrylate, acrylic acid, ethyl acrylate, 2-vinyl anisole, and furfuryl acrylate. Alternatively or in combination, the multi-functional monomer may comprise a di-, tri-, tetra-, or penta-functional monomer. Alternatively or in combination, the multi-functional monomer may comprise ethylene glycol dimethacrylate (EDGMA), trimethylene propane trimethacrylate (Tri-MA), polyethylene glycol diacrylate (PEGA), Trimethylol propane trimethacrylate, Trimethylol propane triacrylate, Pentaerythrytol tetra acrylate, or pentaerythrytol pentaacrylate. Alternatively or in combination, the cross-linked polymer may comprise one or more mono-functional monomer and one or more multi-functional monomer.

In a second aspect, a polymeric hydrogel is provided. The polymeric hydrogel comprises a cured and hydrated mixture of polymerized hydrophilic acrylates and methacrylates, a water-soluble diluent, and a photo-curing catalyst, wherein the polymeric hydrogel material has expanded less than 5% by volume upon hydration to within a range of 30-65% water. The hydrogel may expand less than 1% by volume upon hydration to within a range of 30-65% water.

In many embodiments, the cross-linked polymer may comprise methacrylate. The methacrylate may comprise glyceryl monomethacrylate in the range of 18-25%.

In many embodiments, the hydrogel may have a refractive index in the range of 1.39-1.44 when fully hydrated.

In many embodiments, the water-soluble diluent may comprise a polyethylene glycol of viscosity in the range of 6-20 cSt at 25 C.°.

In many embodiments, the photo-curing catalyst may be capable of being activated by ultraviolet radiation in the wavelength range of 350-440 nm.

In many embodiments, the formulation may be non-ionic and may not comprise salts.

In many embodiments, the formulation may comprise a cross-linker. The cross-linker may comprise a multifunctional methacrylate. The cross-linker may comprise a trifunctional methacrylate, in a weight range of 1.0-2.5% of the cured cross-linked polymer prior to hydration.

In many embodiments, the material may be cured at a temperature not exceeding 55 Co.

In many embodiments, the material may comprise a cross-linker. The cross-linker may comprise a multifunctional methacrylate. The cross-linker may comprise a trifunctional methacrylate, in a weight range of 1.0-2.5%.

In another aspect, a contact lens is provided. The contact lens comprises any of the polymeric hydrogel materials or formulations described herein.

In another aspect, an accommodating soft contact lens is provided. The accommodating soft contact lens comprises any of the polymeric hydrogel materials described herein.

In another aspect, an accommodating soft contact lens is provided. The accommodating soft contact lens comprises any of the polymeric hydrogel materials described herein and a central reservoir comprising a fluid.

In another aspect, an accommodating soft contact lens is provided. The accommodating soft contact lens comprises any of the polymeric hydrogel materials described herein a self-supporting electronics module comprising circuitry embedded in a contact lens.

In another aspect, a method of manufacturing a polymeric hydrogel material is provided. The method comprises combining polymerized hydrophilic acrylates and methacrylates with a water-soluble diluent and a photo-curing catalyst to form a formulation wherein a ratio of concentrations of said acrylates and methacrylates and said diluent is configured to decrease swelling upon hydration.

In many embodiments, the method may further comprise curing the formulation to form a polymeric material portion such that a cure shrinkage of the polymeric material portion is reduced by the diluent. The method may optionally further comprise hydrating the polymeric material portion to form a polymeric hydrogel material such that the polymeric material portion expands less than 5% by volume upon hydration to within a range of 30-65% water. The method may further comprise hydrating the polymeric material portion at 25 C.°. Alternatively or in combination, the ratio of concentrations of the acrylates and methacrylates and the diluent may be or may have been adjusted to change the molar concentration of said acrylates and methacrylates and the molar concentration of said diluent to achieve, upon polymerization and hydration, a percent hydration of the polymeric material portion. The percent hydration may comprise a value within a range from about 35% to about 60%. The polymeric material portion may expand less than 1% by volume upon hydration at 25 C.°.

In another aspect, a method of manufacturing a polymeric hydrogel material is provided. The method comprises providing a formulation comprising (or consisting of) a mixture of polymerized hydrophilic acrylates and methacrylates, a water-soluble diluent, and a photo-curing catalyst that when cured and hydrated forms a cross-linked polymer. A ratio of concentrations of said acrylates and methacrylates and said diluent is configured to decrease swelling upon hydration and wherein a volume of said cross-linked polymer is configured to expand less than 5% by volume upon hydration to within a range of 30-65% water. The method further comprises curing said formulation to form a cross-linked polymer. A volume of the cross-linked polymer is configured to expand less than 5% by volume upon hydration to within a range of 30-65% water. The method further comprises hydrating said formulation to form a cross-linked polymer such that the volume of the cross-linked polymer expands less than 5% by volume upon hydration to within a range of 30-65% water.

In many embodiments, the method further comprises hydrating the polymeric material portion at 25 C.°.

In many embodiments, the ratio of concentrations of the acrylates and methacrylates and the diluent may be adjusted to change the molar concentration of said acrylates and methacrylates and the molar concentration of said diluent to achieve, upon polymerization and hydration, a percent hydration of the polymeric material portion. The percent hydration may comprise a value between 30-60%.

In many embodiments, the methacrylate may comprise glyceryl monomethacrylate. The methacrylate may comprise glyceryl monomethacrylate in the range of 18-25%.

In many embodiments, any of the methods described herein may further comprise providing a formulation comprising a mixture of polymerized hydrophilic acrylates and methacrylates, a water-soluble diluent, and a photo-curing catalyst that when cured and hydrated forms a cross-linked polymer. The volume of said the-linked polymer may expand less than 5% by volume upon hydration at 25 C.°.

In another aspect, a method is provided. The method comprises providing a polymeric hydrogel material comprising (or consisting of) a mixture of polymerized hydrophilic acrylates and methacrylates, a water-soluble diluent, and a photo-curing catalyst that when cured and hydrated forms a cross-linked polymer. The polymer comprises any of the polymers described herein that forms a hydrogel that expands less than 5% by volume upon hydration at 25 C.

In another aspect, a method is provided. The method comprises providing a contact lens comprising any of the polymeric hydrogel materials described herein.

In another aspect, a method is provided. The method comprises providing an accommodating contact lens comprising a central reservoir. The central reservoir comprises a fluid. The contact lens comprises any of the polymeric hydrogel materials described herein.

### INCORPORATION BY REFERENCE

All publications, patents, and patent applications mentioned in this specification are herein incorporated by reference to the same extent as if each individual publication, patent, or patent application was specifically and individually indicated to be incorporated by reference in its entirety.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a top view of a contact lens comprising a low expansion hydrogel material.

FIG. 2 shows a top view of the fluidic module embedded in a contact lens upon primary gaze, in which the fluidic module comprises a central chamber and several peripheral chambers, interconnected via micro-channels;

FIGS. 3A to 3C show design of the fluidic module and chambers, in accordance with embodiments;

FIG. 4 shows a top view of the fluidic module, comprising a central chamber and several peripheral chambers, interconnected via micro-channels, upon downward gaze, in accordance with embodiments;

FIG. 5 shows the percent hydration as a function of GMA content;

FIG. 6 shows the lens diameter as a function of GMA content;

FIG. 7 shows a cup assembly used to cure example formulations in the form of a soft contact lens; and

FIG. 8 shows a process of curing monomer formulations, in accordance with embodiments.

### DETAILED DESCRIPTION OF THE INVENTION

The low expansion polymer materials described herein are well suited for use in many contact lens applications, such as aberration correction and accommodating contact lenses. The contact lens materials disclosed herein can be used with accommodating contact lenses to provide improved results.

As used herein the term “fully hydrated” refers to a hydrogel material hydrated to equilibrium with saline or other solution of comparable ionic strength suitable for placement in or on the eye.

As used herein “C” refers to degrees Centigrade.

As used herein “Wt” refers to weight.

As used herein cSt refers to centistokes.

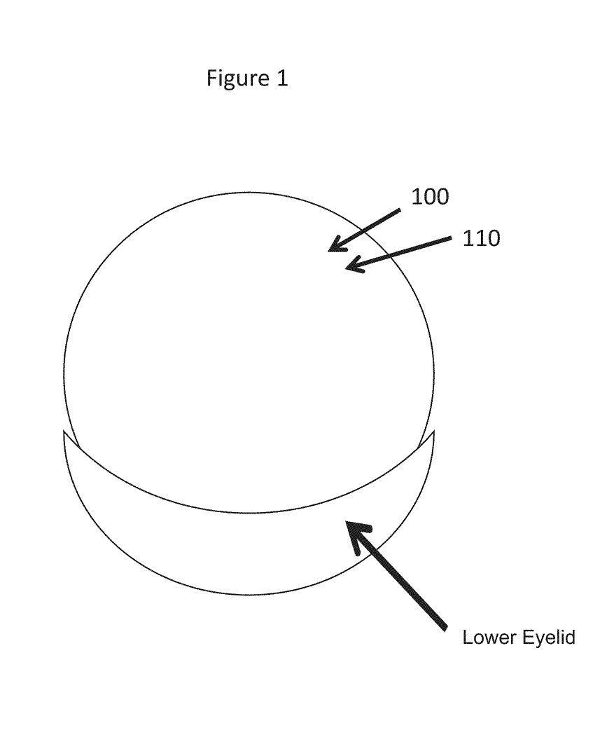

FIG. 1 shows a top view of a contact lens 100 comprising a low expansion hydrogel 110 material as described herein. The contact lens can be used to correct refractive error of the eye, such as nearsightedness, farsightedness, astigmatism, and wavefront aberrations of the eye such as coma, spherical aberration and trefoil. The low expansion hydrogel material provides decreased distortion when hydrated. The hydrogel material is particularly well suited for use with contact lenses benefiting from improved accuracy of the thickness and profiles of the lens corresponding surfaces. Although lens 100 is shown as a contact lens, lens 100 may comprise any biocompatible lens, such as an intraocular lens.

The low expansion hydrogel material can be used with contact lenses to correct presbyopia. The contact lens may comprise a central fluidic chamber and a lower chamber. The lower chamber can be coupled to the central optical chamber with a channel extending there-between. The contact lens to correct presbyopia may optionally comprise a fluidic module.

The central fluidic chamber can be positioned in many ways in relation to the contact lens in order to accommodate anatomical variability of the eye. For example, the central fluidic chamber may be positioned within the contact lens away from a center of the contact lens such that the central fluidic chamber is concentric with the pupil. Alternatively, the central fluidic chamber can be concentric with the contact lens. A person of ordinary skill in the art will recognize that the pupil may be located away from the center of the cornea and design the contact lens accordingly in accordance with the embodiments disclosed herein. This approach allows the center of the central fluidic chamber to be centered on the pupil when the contact lens is placed on the eye. The central fluidic chamber may be concentric or eccentric within the contact lens, such as with respect to the center of the contact lens. The contact lens may be configured such that the optical zone is concentric or eccentric with respect to the center of the contact lens. The contact lens may be configured such that the optical zone is concentric or eccentric with respect to the pupil of the eye.

The diameter or maximum dimension across of the central fluidic chamber may be sized to match the pupil based on physiological norms. The diameter of the central fluidic chamber may be within a range of about 2.5 mm to about 6 mm, for example within a range of about 3 mm to about 6 mm.

The low expansion hydrogel material is particularly well suited for contact lenses comprising a low expansion insert material, in order to decrease deformation that may be related to stress or strain as the hydrogel material expands during the manufacturing process.

The hydrogel material may comprise one or more of a mono-functional monomer or a multi-functional monomer or a mono-functional monomer and a multi-functional monomer. The hydrogel material may comprise any combination of monomers.

Mono-functional monomers may comprise hydroxyethyl methacrylate (HEMA), 2-methoxyethyl methacrylate (MEMA), glyceryl mono-methacrylate (GMA), methacrylic acid (MAA), Aminoethyl methacrylate, acrylamide, 2-vinyl pyrollidone, polyethylene glycol methacrylate, acrylic acid, ethyl acrylate, 2-vinyl anisole, or furfuryl acrylate.

Multi-functional monomers, for example di-, tri-, tetra-, or penta-functional monomers, may comprise ethylene glycol dimethacrylate (EDGMA), trimethylene propane trimethacrylate (Tri-MA), polyethylene glycol diacrylate (PEGA), Trimethylol propane trimethacrylate, Trimethylol propane triacrylate, Pentaerythrytol tetra acrylate, or pentaerythrytol pentaacrylate.

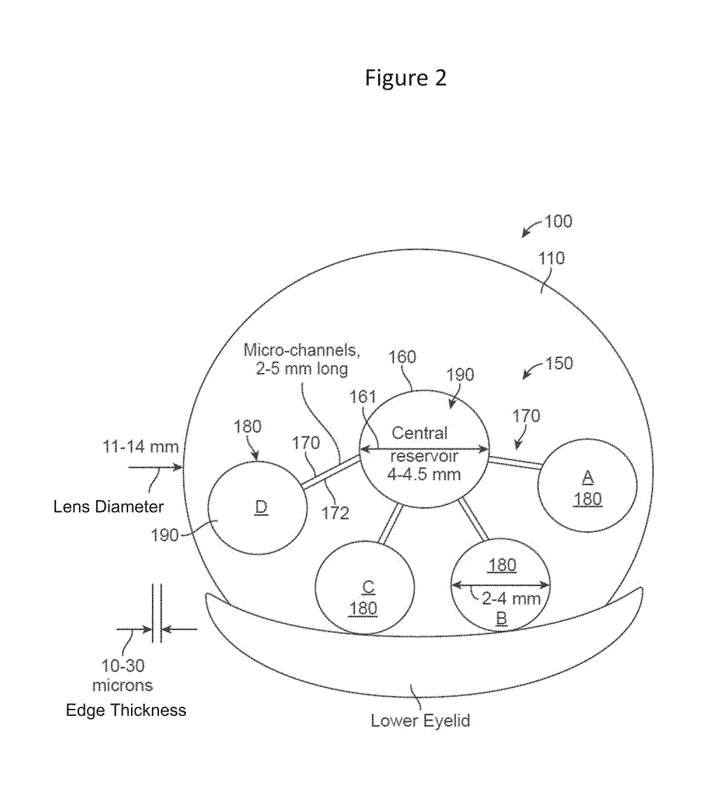

FIG. 2 shows a top view of a contact lens 100 comprising a fluidic module 150 embedded in a low expansion soft contact lens material 110 as described herein. The module 150 comprises a central chamber 160 and several peripheral chambers 180, interconnected via micro-channels 172, upon primary gaze, in accordance with embodiments. The module 150 may comprise an insert placed within a contact lens mold during the manufacturing process as described herein. The module may comprise a low expansion material, which may not expand with the hydrogel material.

In many embodiments, the design comprises a single, hermetically sealed fluidic module that comprises one or more separate chambers, interconnected by means of micro-channels, embedded in a soft contact lens, as shown in FIG. 2.

In many embodiments, the central chamber 160 is cylinder shaped with edges that are relatively stiff, its faces being covered by a relatively flexible distensible membrane. The top and bottom faces can be circular in shape.

The central chamber is connected to each of the peripheral chambers by means of a micro-channel.

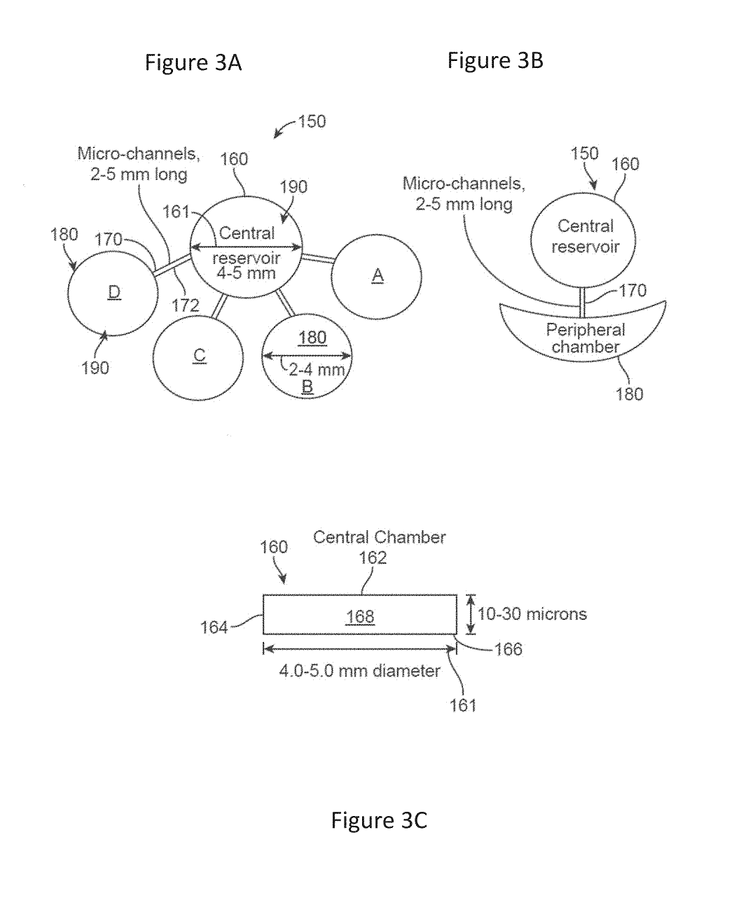

FIGS. 3A-3C show examples of fluidic modules and chambers, in accordance with embodiments.

The shape of the peripheral chambers are also cylindrical, and their top and bottom faces are circular or elongated, as shown in FIGS. 3A-3C.

The fluidic module can be located inside the soft contact lens 100 such that the geometrical center of the lens optic is co-linear with the geometrical center of the central chamber of the fluidic module.

The fluidic module can be filled with a biocompatible fluid 190, preferably of the same refractive index as the material of the soft contact lens, in the range of 1.44 to 1.55 or about 1.40 to about 1.55, for example.

The viscosity of the fluid can be in the range 0.2-2.0 centistokes at 37 C.°, or in the range of about 0.2 to 5.0 centistokes at 37 C.°.

The fluid 190 is preferably a siloxane, a fluorocarbon, an ester, an ether or a hydrocarbon, or combinations thereof, for example.

The membrane is biocompatible, and has an index preferably substantially the same as the fluid and the contact lens itself, in the range 1.44-1.55, or within the range from 1.40 to 1.55, for example.

The membrane may be of the same thickness throughout, or it may have a thickness profile, contoured to control its rigidity or flexibility along the dimensions of the membrane.

The membrane is preferably a fluorocarbon, a polyester, a polyurethane, a polyether, a polyimide, a polyamide, an acrylate or methacrylate ester, or a copolymer bearing these functionalities.

The module may comprise on or more of many optically transmissive materials, such as one or more of a plastic, a polymer, a thermo plastic, a fluoropolymer a non-reactive thermoplastic fluoropolymer, or polyvinylidene difluoride (hereinafter “PVDF”), for example.

The micro-channels are fabricated from a biocompatible material, and may be a fluorocarbon, a polyester, a polyimide, a polyamide, an epoxide, an acrylate or methacrylate ester, or a hydrocarbon such as polypropylene or polyethylene.

The walls of the central chamber of the module may either be composed of the same material as the membrane on the two sides, or it may be made of a different material.

The fluidic module 150 can be embedded in the soft contact lens 100 such that the module is close to the anterior (convex) surface of the lens.

Preferably there is a thin layer of contact lens material above the fluidic module, its thickness being in the range of 5-10 microns.

Being close to the surface of the contact lens, a change in curvature of the fluidic module (caused by inflation or deflation through fluid transfer between the central and peripheral chambers) causes a corresponding change in the anterior curvature of the soft contact lens.

The diameter 161 of the central chamber 160 can be at least about 3 mm, for example within a range from about 3.0 to 5.0 mm, such as a range from about 3.0 to about 4.5 mm, for example within a range from about 4.0-4.5 mm, while the length of the edge can be about 10-40 microns.

The thickness of the membranes 162, 166, comprising the top and the bottom surfaces of the central chamber can be in the range 5-20 microns.

The thickness of the membrane comprising the edge 164 can be in the range 10-50 microns.

The peripheral chambers 180 have a total area of 5.0-8.0 mm² and a thickness of 10-30 microns each.

The total volume of the sealed module can be in the range of 0.15-0.80 mm3, or 0.15-0.80 microliter, or from about 0.15 to about 2.50 mm³ (about 0.15 to about 2.50 microliter), for example.

Each micro-channel can be about 10-30 microns in internal diameter and about 2-5 mm long, or from about 1 to about 5 mm long, for example.

The micro-channels may be designed to have a uniform internal diameter or it may have micro-indentations oriented to impede flow in one direction in preference to the other.

The purpose of these indentations can be to modulate the response time of the onset and removal of the additional plus power after the down-gaze.

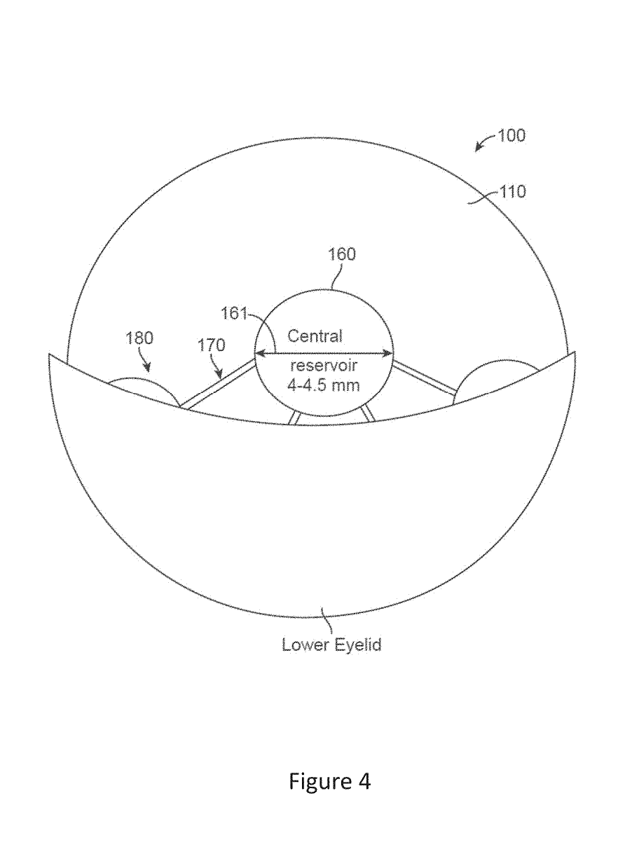

FIG. 4 shows a top view of the fluidic module, comprising a central chamber and several peripheral chambers, interconnected via micro-channels, upon downward gaze, in accordance with embodiments.

The mechanism of action involves movement of the scleral sphere caused by down-gaze typically occurring when the wearer attempts to read or perform a near vision task.

The eyeball moves down by about 20 degrees-60 degrees, depending on the amount of down-gaze, causing the corneal surface to rotate down by about 2.0 mm-6.0 mm

The peripheral chambers slide under the lower eyelid and can be compressed, as shown in FIG. 4.

A 2.0 mm downward movement of the lens positioned on the cornea will cause partial (30-60%) compression, while a 4.0 mm or greater eye movement will cause the entire peripheral chamber to be compressed.

In many embodiments eyelid caused compression will be able to expel a fraction (20%-60%) of the fluid in the peripheral chamber(s) when the totality of peripheral chambers move under the lower eyelid.

The fluid moves travels through the micro-channels connected at the distal end to the central chamber, and increases the hydrostatic pressure in the central chamber.

The hydrostatic pressure, being equal in all directions, causes application of a spherical inflationary force on the membrane on the top and bottom faces.

This inflation may be preferentially directed to the top surface by using a thicker membrane at the top surface, rendering it stiffer than the membrane covering the bottom surface of the central chamber.

In some embodiments, the hydrostatic pressure may be equal in all directions, and consequently causes a spherical inflation of the membrane on the top and bottom faces.

In many embodiments, the relative extent of inflation of the top and the bottom faces can be adjusted by adjusting the thickness of the membranes covering the top and bottom faces and providing an accommodating module having an appropriate thickness of each of the top and bottom membranes.

Similarly, the edge can be rendered less distensible by using a relatively thick walled membrane for its fabrication.

In many embodiments, a 2.0D increase in power can be achieved by a 5.0-7.0 micron sag height change of the anterior (top) surface of the central chamber, when the central chamber is within a range from about 3.0 mm to about 5.0 mm, for example about 4.0 mm in diameter. Alternatively or in combination, a 2.0D increase in power can be achieved by a 5.0-15.0 micron sag height change of the anterior (top) surface of the central chamber, when the central chamber is within a range from about 3.0 mm to about 5.0 mm, for example about 4.0 mm in diameter.

This change in curvature can be effected by injection of fluid of volume equal to 0.10-0.15 microliters. Alternatively or in combination, the change in curvature can be effected by injection of fluid of volume within a range from about 0.07 to about 0.21 microliters, for example.

In many embodiments, the total volume of fluid to be expelled from the peripheral chambers to the central chamber due to eyelid pressure can be within a range from about 0.10 to about 0.30 microliters. Alternatively or in combination, the total volume of fluid to be expelled from the peripheral chambers to the central chamber due to eyelid pressure can be within a range from about 0.07 to about 0.30 microliters.

As shown in FIGS. 1-3, the central optical chamber 160 comprising the reservoir is connected to the one or more eyelid engaging chambers with one or more extensions 170 comprising one or more channels 172. The one or more eyelid engaging chambers 180 may comprise a plurality of eyelid engaging chambers, such as chamber A, chamber B, chamber C, and chamber D. A plurality of extensions comprising a plurality of channels connects the plurality of chambers to the central optical chamber. The micro-channels extend between the central optical chamber and each of the plurality of chambers.

The plurality of eyelid engaging chambers can be arranged in one or more of many ways. For example, the eyelid engaging chambers can be arranged to engage the eyelid sequentially, simultaneously, incrementally, or in combinations thereof, for example.

The plurality of eyelid engaging chambers can be arranged to provide incremental amounts of optical power to the central optical chamber upon increasing engagement of the lower eyelid with the plurality of chambers. In many embodiments, a first eyelid engaging chamber such as chamber B or chamber C engages the eyelid before a second eyelid engaging chamber such as chamber A or chamber D. Engagement of the first eyelid engaging chamber can urge a first amount of fluid into the central optical chamber to provide a first amount of optical power. Engagement of the second eyelid engaging chamber can urge a second amount of fluid into the central optical chamber to provide a second amount of optical power greater than the first amount of optical power. The first amount of fluid from the first eyelid engaging chamber can be combined with the second amount of fluid from the second eyelid engaging chamber to provide the second amount of optical power greater than the first amount of optical power, for example. In many embodiments, the first amount of fluid can be combined with the second amount of fluid within the central optical chamber to provide the increased optical power.

In many embodiments, the first chamber comprises a first plurality of chambers, and the second chamber comprises a second plurality of chambers, for example. Chambers B and C may comprise a first plurality of chambers, each contributing an amount of optical power within a range from about 0.25 Diopters to about 0.75 Diopters, for example. Chambers A and D may comprise a second plurality of chambers, each contributing an amount of optical power within a range from about 0.25 Diopters to about 0.75 Diopters, for example. For example, each of chambers A, B, C, and D may provide about 0.5 Diopters of correction, and engagement of chambers B and C provides about 1 D of additional optical power with a first position of the lens in relation to the eyelid, and engagement of chambers A, B, C, and D provides about 2 D of additional optical power with a second position of the eyelid in relation to the lens.

The peripheral chambers can be configured in many ways when connected to the central chamber in order to provide accommodation. While the peripheral fluid chambers are shown as lower fluid chambers which may interact with the lower eyelid to contribute to the accommodation of the lens, the upper lid may, alternatively or in combination, contribute to the accommodation of the contact lens in many instances as well. The upper lid may engage one or more of the fluid chambers during down-gaze or squinting, thereby compressing the fluid chamber(s) and altering the shape of at least the central optical chamber in order to alter the optical power as described herein. The peripheral chamber(s) may be connected to the central chamber and sized and shaped in many ways, for example, with an annular peripheral chamber extending around the central optical chamber. Alternatively or in combination, the upper lid may engage one or more upper fluid chambers disposed above the central optical chamber. The upper fluid chamber(s) may be coupled to the central optical chamber by an upper channel to allow fluid to flow between the upper fluid chamber(s) and the central optical chamber. The contact lens may comprise any combination of a central optical chamber, an upper fluid chamber, and a lower chamber. The contact lens may, for example, comprise a central optical chamber coupled to an upper fluid chamber by an upper channel and a lower fluid chamber by a lower fluid channel as described herein. The contact lens may alternatively comprise a central optical chamber and one or more upper fluid chambers without a lower reservoir. Engagement of the upper fluid chamber(s) with the upper eyelid may function to adjust the optical power of the lens in a near vision configuration or far vision configuration in a manner substantially similar to that of the lower fluid chamber(s) described herein.

The low expansion hydrogel contact lens material disclosed herein comprises a formulation configured with contact lens properties, such as refractive index, oxygen permeability, biocompatibility, hydration amount, modulus, and fracture resistance. The formulation can be modified to provide beneficial cross-link density, randomness, and hence homogeneity. The properties can be when the material is diluted with a diluent that is added at a concentration approximately equal to the expected water content at equilibrium hydration, for example. Since addition of a diluent may alter the curing process and cross-link density of the polymer, the present inventors have conducted several iterative studies of a low expansion formulation having the properties described herein.

The present inventors have discovered that a formulation comprising mono-functional and multifunctional acrylates and methacrylates, a photo-curing agent, and a diluent that is water soluble, preferably forming a homogenous mixture, which can be used to cast a contact lens of appropriate physical properties. The formulation may consist of the above components. Although such a formulation may be cured either thermally, photo-chemically, or using a combination of heat and light leading to a photo-thermal cure, it has been found that photochemical cure at a moderate temperature can work very well to manufacture a contact lens containing an embedded insert. The cure process or the subsequent demolding and hydration as disclosed herein does not cause distortion in the lens, the insert or the interface. Preferably, the cure temperature does not exceed 60 C.°. More preferably the cure temperature is within the range of 15 C.° to 45 C.°.

In developing a monomer formulation, the present inventors developed an appropriate balance of hydrophilicity, cross-link density, and length between adjacent cross-links, by varying the concentration and viscosity of the diluent as well as that of the monomer constituents, while keeping the cure catalyst at the same concentration. The present inventors tested both ionic and non-ionic monomers, in order to determine if ionic monomers provided some additional benefits regarding hydration amount.

The present inventors found that a series of low expansion formulations may be prepared of hydration amounts ranging from 30-60% by weight, preferably in the range 33% to 55%. In this disclosure percent hydration is defined as:

$$\frac{{Wt}_{1} - {Wt}_{2}}{{Wt}_{2}} \times 100$$

where Wt₁ is the weight of the polymer equilibrated in saline or deionized water and Wt₂ is the weight of the dry polymer.

Percent hydration was measured by hydrating the polymerized material until equilibrium is reached, then quickly removing it, and patting the polymerized material dry to remove water drops on the surface, before weighing it. This hydrated polymer is then dried in an oven that may be a convection oven or a vacuum oven at an elevated temperature (50-80 C.°, preferably 55 C.°) for 24 hours or longer until the dry weight reaches a lower plateau.

The following monomers were tested:
Mono-functional monomers: Hydroxyethyl methacrylate (HEMA), 2-methoxyethyl methacrylate (MEMA), glyceryl mono-methacrylate (GMA), methacrylic acid (MAA).
Multi-functional Monomers: Ethylene glycol dimethacrylate (EDGMA), trimethylene propane trimethacrylate (Tri-MA), polyethylene glycol diacrylate (PEGA).
Photo-curing agent: Trimethyl benzoylpheyl phosphine oxide (TPO)
Diluents: Polyethylene glycol 1000, polyethylene glycol 650, polyethylene glycol 600. polyethylene glycol 575, polyethylene glycol 500 (PEG 600, etc.).

Table 1 gives some examples of tested monomer formulations.

TABLE 1
Examples of tested monomer formulations.

| Example no. | Components | Wt (g) | Wt (%) |
|---|---|---|---|
| No 97 | Tri-MA | 0.172 | 1.10% |
| | MEMA | 2.2308 | 14.32% |
| | HEMA | 2.52 | 16.17% |
| | GMA | 3.42 | 21.95% |
| | TPO-L | 0.14 | 0.90% |
| | PEG600 | 7.1 | 45.56% |
| | | 15.5828 | 100.00% |
| No 98 | Tri-MA | 0.14 | 1.01% |
| | MEMA | 2.2308 | 16.09% |
| | HEMA | 2.8 | 20.20% |
| | GMA | 3.05 | 22.00% |
| | TPO-L | 0.14 | 1.01% |
| | PEG600 | 5.5 | 39.68% |
| | | 13.8608 | 100.00% |
| No 3 | Tri-MA | 0.1004 | 0.90% |
| | MEMA | 2.057 | 18.48% |
| | HEMA | 5.8882 | 52.89% |
| | TPO-L | 0.072 | 0.65% |
| | PEG600 | 3.015 | 27.08% |
| | | 11.1326 | 100.00% |
| No 15 | Tri-MA | 0.1004 | 0.95% |
| | MEMA | 2.057 | 19.50% |
| | HEMA | 4.2 | 39.82% |
| | MAA | 1.12 | 10.62% |
| | TPO-L | 0.056 | 0.53% |
| | PEG600 | 3.015 | 28.58% |
| | | 10.5484 | |
| No 68 | Tri-MA | 0.108 | 0.74% |
| | MEMA | 2.223 | 15.27% |
| | HEMA | 6.313 | 43.35% |
| | TPO-L | 0.097 | 0.67% |
| | PEG600 | 5.820 | 39.97% |
| | | 14.561 | 100.00% |
| No 69 | Tri-MA | 0.108 | 0.61% |
| | MEMA | 2.223 | 12.70% |
| | HEMA | 6.313 | 36.04% |
| | TPO-L | 0.120 | 0.69% |
| | PEG600 | 8.750 | 49.96% |
| | | 17.514 | 100.00% |
| No 64 | Tri-MA | 0.108 | 0.83% |
| | MEMA | 2.2308 | 17.06% |
| | HEMA | 1.771 | 13.54% |
| | GMA | 5.622 | 42.98% |
| | TPO-L | 0.084 | 0.64% |
| | PEG600 | 3.264 | 24.95% |
| | | 13.0798 | 100.00% |
| No 65 | Tri-MA | 0.108 | 0.81% |
| | MEMA | 2.2308 | 16.79% |
| | HEMA | 0.857 | 6.45% |
| | GMA | 6.746 | 50.76% |
| | TPO-L | 0.084 | 0.63% |
| | PEG600 | 3.264 | 24.56% |
| | | 13.2898 | 100.00% |

Some of the formulations required sonication to be removed from their mold. The diameter of the cast film was measured under a microscope before and after hydration. Percent hydration was calculated by measuring the weight of the film before and after hydration.

It was found that use of EGDMA as the cross-linker caused the cross-linked hydrogel to become brittle, while the use of trimethylol propane trimethacrylate promoted toughness and produced structures with higher elongation at break.

Table 2 shows the water of hydration of these compositions and the diameter after hydration was complete. Initial lens diameter prior to hydration was 14.5 mm in all cases.

TABLE 2
Calculation of volume expansion and percent
hydration of several example formulations.

| | | | | | | Avg | |
|---|---|---|---|---|---|---|---|
| | Mass, | Mass, | Mass, | Avg % | Avg | Sag | Vol |
| Exam- | init | swollen | dry | Hydra- | Diam | Ht | in- |
| ple | (g) | (g) | (g) | tion | (mm) | (mm) | crease |
| 3 | 0.0707 | 0.0694 | 0.0522 | 24.78% | | | |
| 15 | 0.0704 | 0.0669 | 0.0527 | 21.23% | | | |
| 64 | | 0.2342 | 0.1012 | 57.81% | 18.0 | 5.00 | 83.0% |
| 65 | | 0.2141 | 0.0864 | 59.65% | 20.0 | 5.50 | 249% |
| 68 | 0.0874 | 0.0945 | 0.0515 | 45.50% | 14.00 | 3.70 | −17.9% |
| 69 | 0.1127 | 0.1819 | 0.0555 | 69.49% | N/A | N/A | |
| 97 | 0.0904 | 0.1005 | 0.0489 | 51.34% | 14.50 | 4.20 | 0.0% |
| 98 | 0.1008 | 0.1201 | 0.0606 | 49.54% | 14.80 | 4.30 | 6.0% |

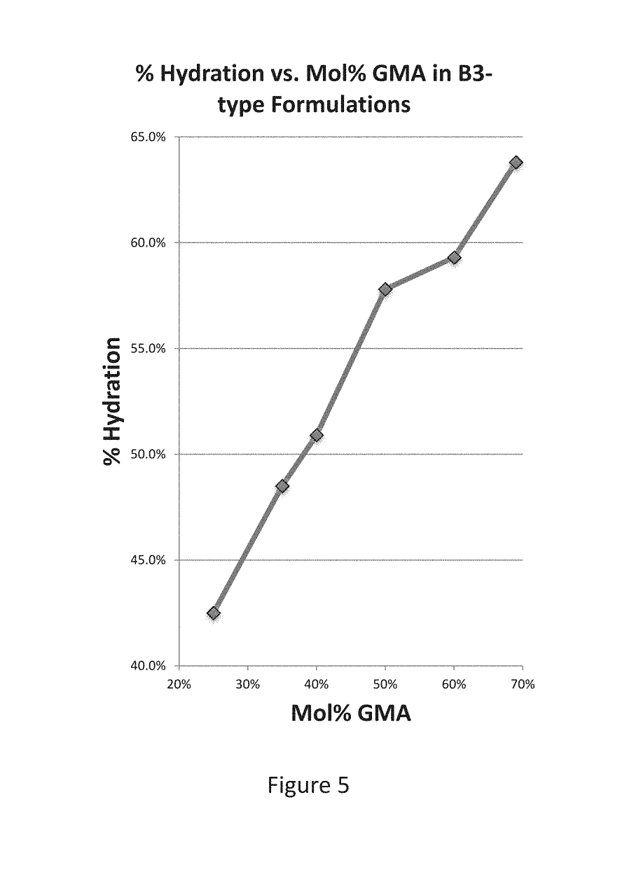

It was further found that while addition of methacrylic acid had little effect on hydration, addition of glyceryl dimethacrylate (GMA) caused a steady increase in hydration as the mole fraction of GMA increased in the formulation. FIG. 5 shows the dependence of hydration with the relative concentration of glyceryl monomethacrylate.

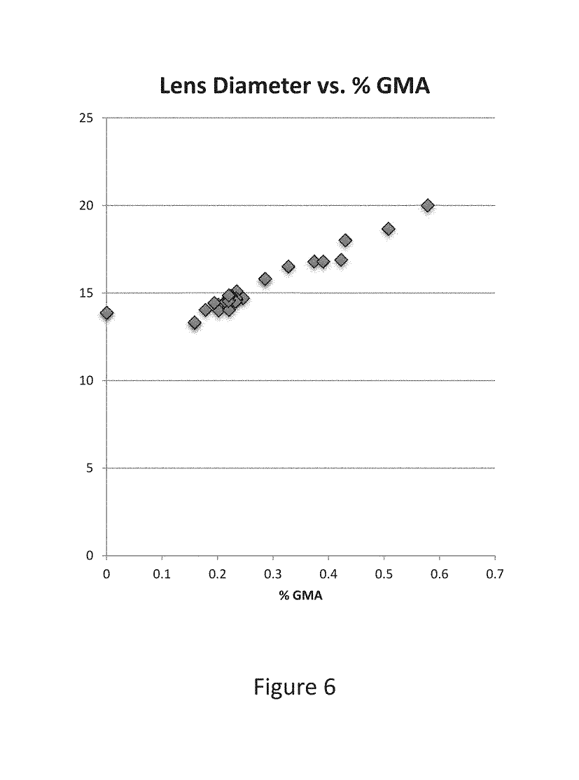

The increase in hydration amount causes the cured lens to expand more as the GMA content increases, since the diluent is no longer able to compensate the resulting expansion, as shown in FIG. 6. As noted above, the lens diameter was 14.5 mm prior to hydration. Use of a higher amount of diluent is therefore warranted, but increase in diluent content also reduces cross-link density and therefore further increases hydration amount. Adjustment of the concentration of GMA in the formulation was therefore found to be an important driver of the hydration amount of the low expansion polymer system. A low expansion formulation (example 3) can be prepared at a hydration amount of 32%, if no GMA is added. Such a formulation may be suitable for biomedical implants, but may be a bit too low for some soft contact lens applications, for example.

The present inventors have developed a method to obtain a low expansion hydrogel with percent hydration anywhere in the range from about 30% to about 65%, by controlling the molar concentration of GMA in the formulation and also the ratio of molar concentrations of GMA and the diluent. Low expansion hydrogels at the lower end of the range of percent hydration may not benefit from any GMA in the formulation. In developing a low expansion hydrogel with a targeted percent hydration amount, it is preferable to test a series of compositions that have expansion going from positive to negative values, in other words, testing formulations that undergo volumetric contraction or shrinkage upon hydration, as shown in Table 2 (example 68).

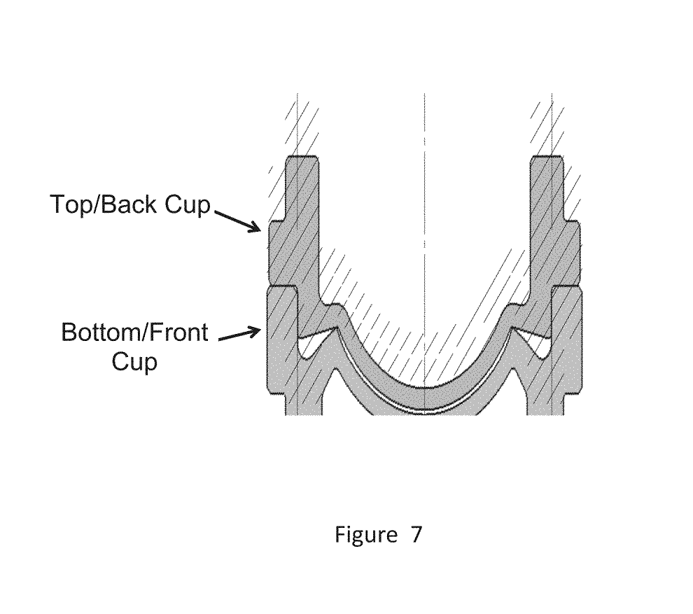

FIG. 7 illustrates top and bottom cups that can be used to cure the example formulations as described herein. Such molds are well known to persons of ordinary skill in the art.

Examples of modules and molding processes suitable for incorporation with the low expansion hydrogel material as disclosed herein are described in PCT/US2014/013427, filed on 28 Jan. 2014, entitled “Accommodating Soft Contact Lens” (attorney docket no. 44910-703.601); PCT/US2014/013859, filed on Jan. 30, 2014, entitled “Manufacturing Process of an Accommodating Contact Lens” (attorney docket no. 44910-704.601); PCT/US2014/071988, filed on Dec. 22, 2014, entitled “Fluidic Module For Accommodating Soft Contact Lens” (attorney docket no. 44910-705.601); and PCT/US2015/0433307, filed 31 Jul. 2015, entitled “LOWER LID ACTIVATING AN ELECTRONIC LENS”; the entire disclosures of which have been previously incorporated herein by reference. For example the lens may comprise a self-supporting electronics module comprising circuitry embedded in the hydrogel material as disclosed herein.

### Curing Process

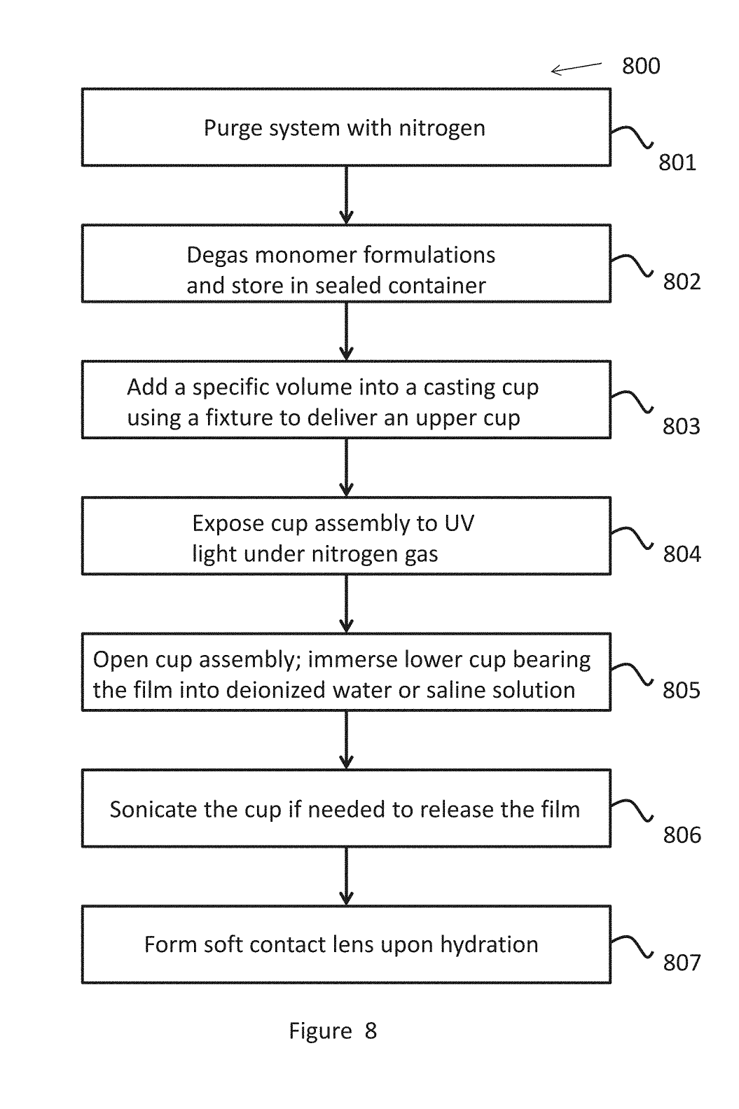

FIG. 8 shows a process 800 of curing the monomer formulations in accordance with embodiments. In step 801, the system is initially purged with nitrogen and is maintained under nitrogen when the monomer formulation is delivered into the cup. In step 802, the monomer formulations are degassed, and stored in a sealed container. In step 803, a specific volume is added into a casting cup made of pure polyethylene, using a fixture to align the delivery pipette with the base cup, so as to avoid forming bubbles. The fixture is used to deliver an upper cup on the liquid layer, and snapped shut on the rim of the lower cup. In step 804, the cup assembly is exposed to UV light uniformly throughout the surface of the cups under nitrogen gas. Exposure to UV light (391 nm, produced by an LED light source) causes the monomer formulation to cure and cross-link, forming a lens shaped film. In step 805, the cup assembly is opened, and the lower cup bearing the film is immersed into either deionized water or saline solution (0.9% NaCl in water). In step 806, the cup may be sonicated in order to release the film. In step 807, the film becomes hydrated and forms a soft contact lens of required diameter, radii of curvatures and thickness. In our case, the target diameter was 14.5 mm, radius of curvatures of both surfaces was 8.6 mm, and the lens thickness at the center of the lens was 225 microns.

A person of ordinary skill in the art will recognize many adaptations and variations in accordance with the embodiments disclosed herein. For example some of the steps can be deleted; additional steps can be performed; the order of the steps can be changed; some of the steps comprise sub-steps; some of the steps can be repeated and some of the steps may comprise one or more steps of other methods as disclosed herein.

1. A formulation comprising (or consisting of) a mixture of polymerized hydrophilic acrylates and methacrylates, a water-soluble diluent, and a photo-curing catalyst that when cured and hydrated forms a cross-linked polymer and wherein a volume of said cross-linked polymer is configured to expand less than 5% by volume upon hydration to within a range of 30-65% water.

2. The formulation of claim 1, wherein said cross-linked polymer expands less than 1% by volume upon hydration to within a range of 30-65% water.

3. The formulation of claim 1 or 2, wherein said hydration comprises hydration at 25 C.°.

4. The formulation of claim 1, wherein said cross-linked polymer comprises methacrylate and said methacrylate comprises glyceryl monomethacrylate in the range of 18-25%.

5. The formulation of claim 1, wherein said cross-linked polymer has a refractive index in the range of 1.39-1.44 in the hydrated state.

6. The formulation of claim 1, wherein said water-soluble diluent comprises a polyethylene glycol of viscosity in the range of 6-20 cSt at 25 C.°.

7. The formulation of claim 1, wherein said photo-curing catalyst is capable of being activated by ultraviolet radiation in the wavelength range of 350-440 nm.

8. The formulation of claim 1, wherein said formulation is non-ionic.

9. The formulation of claim 1, wherein said formulation comprises a cross-linker, said cross-linker comprising a multifunctional methacrylate.

10. The cross-linker of claim 9, wherein said cross-linker comprises a trifunctional methacrylate, in a weight range of 1.0-2.5% of the cured cross-linked polymer prior to hydration.

11. The formulation of claim 1, wherein said cross-linked polymer is comprised of one or more of a mono-functional monomer or multi-functional monomer.

12. The formulation of claim 11, wherein said mono-functional monomer comprises hydroxyethyl methacrylate (HEMA), 2-methoxyethyl methacrylate (MEMA), glyceryl mono-methacrylate (GMA), methacrylic acid (MAA), Aminoethyl methacrylate, acrylamide, 2-vinyl pyrollidone, polyethylene glycol methacrylate, acrylic acid, ethyl acrylate, 2-vinyl anisole, and furfuryl acrylate.

13. The formulation of claim 11, wherein said multi-functional monomer comprises a di-, tri-, tetra-, or penta-functional monomer.

14. The formulation of claim 11, wherein said multi-functional monomer comprises ethylene glycol dimethacrylate (EDGMA), trimethylene propane trimethacrylate (Tri-MA), polyethylene glycol diacrylate (PEGA), Trimethylol propane trimethacrylate, Trimethylol propane triacrylate, Pentaerythrytol tetra acrylate, or pentaerythrytol pentaacrylate.

15. The formulation of claim 11, wherein said cross-linked polymer comprises one or more mono-functional monomer and one or more multi-functional monomer.

16. A polymeric hydrogel material comprising a cured and hydrated mixture of polymerized hydrophilic acrylates and methacrylates, a water-soluble diluent, and a photo-curing catalyst, wherein said polymeric hydrogel material has expanded less than 5% by volume upon hydration to within a range of 30-65% water.

17. The material of claim 16, wherein said hydrogel expands less than 1% by volume upon hydration to within a range of 30-65% water.

18. The material of claim 16, wherein said hydrogel comprises methacrylate and said methacrylate comprises glyceryl monomethacrylate in the range of 18-25%.

19. The material of claim 16, wherein said hydrogel has a refractive index in the range of 1.39-1.44 when fully hydrated.

20. The material of claim 16, wherein said hydrogel has a hydration amount in the range of 30-65%.

21.-45. (canceled)
